(19) United States
(12) Patent Application Publication
(10) Pub. No.: US 2026/0331768 A1
(43) Pub. Date: Oct. 22, 2026

(54) UNIT CELLS AND WIRELESS COMMUNICATION REFLECTORS HAVING A SMALL GAP SIZE AND METHODS FOR FABRICATING THE SAME

(71) Applicant: CORNING RESEARCH & DEVELOPMENT CORPORATION, Corning, NY (US)

(72) Inventors: Hyeng-cheul Choi, Seoul (KR); Jae-won Huh, Asan-city (KR); Boyoung Kang, Asan-si (KR); Byounggwan Kang, Painted Post, NY (US); Changhyeong Lee, Asan-si (KR)

(21) Appl. No.: 19/675,813

(22) Filed: May 13, 2026

Related U.S. Application Data
(63) Continuation of application No. PCT/US2024/056031, filed on Nov. 15, 2024.
(60) Provisional application No. 63/603,329, filed on Nov. 28, 2023.

(51) Int. Cl. H01Q 3/46

(52) U.S. Cl. CPC H01Q 3/46

(57) ABSTRACT

Unit cells, wireless communications reflectors, and methods for fabricating wireless communications reflectors are disclosed. In one embodiment, a unit cell for a reconfigurable intelligent surface of a wireless communications reflector, the unit cell includes a top dielectric layer, a top conductive layer disposed on a surface of the top dielectric layer, where the top conductive layer includes a ring resonator and at least one top voltage bias line electrically coupled to the ring resonator, a bottom dielectric layer, a bottom conductive layer disposed on a surface of the bottom dielectric layer facing the top dielectric layer, where the bottom conductive layer includes a conductive structure having a shape corresponding to the ring resonator and further includes at least one bottom voltage bias line, and a liquid crystal layer materials positioned between the top dielectric layer and the bottom dielectric layer.

### CROSS-REFERENCE TO RELATED APPLICATION

This application is a continuation of Internation Patent Application No. PCT/US2024/056031, filed on Nov. 15, 2024, which claims the benefit of priority of U.S. Provisional Application No. 63/603,329, filed on Nov. 28, 2023, the content of which is relied upon and incorporated herein by reference in its entirety.

### BACKGROUND

To secure a wider bandwidth than conventional wireless communications (2G-4G), 5G and 6G wireless communications newly adopt a mmWave band that is typically defined as an electromagnetic wave within the 30-300 GHz frequency range. However, there are challenges in transmitting and receiving wireless signals from mmWave bands due to significantly higher propagation loss and reflection loss by obstacles. This is because of the shorter wavelengths than previous frequency ranges for communications, which severely degrades the link budget. High gain phased array antennas are widely employed to compensate for propagation loss. However, a gain in a phased array antenna is saturated due to the feeding network and physical limitations of the aperture in cases of base stations. For mobile devices, the large space and volume requirements for a phased array is not always possible, so it has a lower antenna gain. To overcome these issues, some network operators provide repeaters using amplifiers with semiconductors to solve high loss problems, but the increased cost is unavoidable because many expensive repeaters for 5G and 6G should be installed near a base station to increase their coverage. Additionally, the repeaters have to be installed in specific locations that can reach electrical power sockets because they consume a large amount of power.

Accordingly, alternative devices and methods for expanding mmWave wireless communication coverage may be desired.

### SUMMARY

In one embodiment, a unit cell for a reconfigurable intelligent surface of a wireless communications reflector includes a top dielectric layer, a top conductive layer disposed on a surface of the top dielectric layer, where the top conductive layer includes a ring resonator and at least one top voltage bias line electrically coupled to the ring resonator, a bottom dielectric layer, a bottom conductive layer disposed on a surface of the bottom dielectric layer facing the top dielectric layer, where the bottom conductive layer includes a conductive structure having a shape corresponding to the ring resonator and further includes at least one bottom voltage bias line, and a liquid crystal layer disposed between the top dielectric layer and the bottom dielectric layer.

In another embodiment, a wireless communications reflector includes a top dielectric layer. The wireless communications reflector also includes a top conductive layer disposed on a surface of the top dielectric layer, a bottom dielectric layer. The wireless communications reflector also includes a bottom conductive layer disposed on a surface of the bottom dielectric layer facing the top dielectric layer, and a liquid crystal layer disposed between the top dielectric layer and the bottom dielectric layer, where the top conductive layer and the bottom conductive layer define an array of unit cells, each unit cell includes a ring resonator and at least one top voltage bias line electrically coupled to the ring resonator at the top conductive layer, and a conductive structure having a shape corresponding to the ring resonator and at least one bottom voltage bias line at the bottom conductive layer.

In one aspect, a method of fabricating a wireless communications reflector includes establishing an array of unit cells includes a top dielectric layer. The method also includes establishing an array of unit cells includes a top conductive layer disposed on a surface of the top dielectric layer, a bottom dielectric layer. The method also includes establishing an array of unit cells includes a bottom conductive layer disposed on a surface of the bottom dielectric layer facing the top dielectric layer, and a liquid crystal layer disposed between the top dielectric layer and the bottom dielectric layer, where the top conductive layer and the bottom conductive layer define the array of unit cells, each unit cell includes a ring resonator and at least one top voltage bias line electrically coupled to the ring resonator at the top conductive layer, and a conductive structure having a shape corresponding to the ring resonator and at least one bottom voltage bias line at the bottom conductive layer, where each unit cell is configured to be set to a zero-state or a one-state based on a voltage differential applied to the at least one top voltage bias line and the at least one bottom voltage bias line, and there is a phase difference within a range of 160 degrees to 200 degrees, including endpoints, between a phase of the unit cell in the zero-state and a phase of the unit cell in the one-state. The method also includes randomly assigning each unit cell of the array of unit cells to the zero-state or the one-state to define a state pattern for the array of unit cells. The method also includes determining, using a genetic algorithm, an optimal state pattern of the array of unit cells for a predetermined reflection angle for a reflected wave for an incident wave having a predetermined frequency.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment for a wireless communications reflector according to one or more embodiments described and illustrated herein.

FIG. 2 illustrates an example wireless communications reflector according to one or more embodiments described and illustrated herein.

FIG. 3 illustrates an example unit cell in a zero-state according to one or more embodiments described and illustrated herein.

FIG. 4 illustrates an example unit cell in a one-state according to one or more embodiments described and illustrated herein.

FIG. 5 illustrates a top-down view of an example unit cell according to one or more embodiments described and illustrated herein.

FIG. 6 illustrates a top-down view of a top conductive layer of a unit cell according to one or more embodiments described and illustrated herein.

FIG. 7 illustrates a top-down view of a liquid crystal layer of a unit cell according to one or more embodiments described and illustrated herein.

FIG. 8 illustrates a top-down view of a bottom conductive layer of a unit cell according to one or more embodiments described and illustrated herein.

FIG. 9 illustrates a side view of an example unit cell according to one or more embodiments described and illustrated herein.

FIG. 10 illustrates an example unit cell in simulation according to one or more embodiments described and illustrated herein.

FIG. 11 illustrates a graph that plots the amplitude of a reflected wave for a frequency f₀ versus voltage for both the zero-state and the one-state according to one or more embodiments described and illustrated herein.

FIG. 12 illustrates a graph that plots the amplitude of a reflected wave versus frequency for both the zero-state and the one-state according to one or more embodiments described and illustrated herein.

FIG. 13 illustrates a graph that plots the reflection phase in degrees versus voltage for both the zero-state and the one-state according to one or more embodiments described and illustrated herein.

FIG. 14 illustrates a graph that plots the reflection phase in degree versus frequency for both the zero-state and the one-state according to one or more embodiments described and illustrated herein.

FIG. 15 illustrates an array of unit cells according to one or more embodiments described and illustrated herein.

FIG. 16 illustrates a graph that plots EM simulated results of an LC RIS unit cell according to one or more embodiments described and illustrated herein.

FIG. 17 illustrates a wireless communications reflector wherein each unit cell is set to the zero-state according to one or more embodiments described and illustrated herein.

FIG. 18 illustrates a wireless communications reflector wherein each unit cell is randomly set to the zero-state or the one-state according to one or more embodiments described and illustrated herein.

FIG. 19 illustrates a wireless communications reflector wherein each unit cell is set to a zero-state or a one-state according to an optimized state pattern according to one or more embodiments described and illustrated herein.

FIG. 20 illustrates a flowchart of an example method for determining an optimal state pattern according to one or more embodiments described and illustrated herein.

FIG. 21 illustrates a unit cell in simulation according to one or more embodiments described and illustrated herein.

FIG. 22 illustrates a unit cell array wherein each unit cell is randomly assigned a zero-state or a one-state according to one or more embodiments described and illustrated herein.

FIG. 23 illustrates a process of generating offspring and mutations for unit cells in a genetic algorithm optimization process according to one or more embodiments described and illustrated herein.

FIG. 24 illustrates a graph that plots the magnitude of the reflection coefficient for each unit cell state according to one or more embodiments described and illustrated herein.

FIG. 25 illustrates a graph that plots the reflection phase for each unit cell state according to one or more embodiments described and illustrated herein.

### DETAILED DESCRIPTION

Embodiments of the present disclosure are directed to wireless communications reflectors having a reconfigurable intelligent surface (RIS) to improve propagation channel conditions between base stations and mobile devices. A RIS includes sub-wavelength resonators that adaptively reflect, transmit, absorb, and convert the polarizations of the incident waves with ultra-low power consumption. A RIS can be fabricated at a low cost due to its simple components such as substrates, conductive materials, and impedance control components (in the cases of active RIS products). Taking advantage of these characteristics, the RIS is mainly used to overcome the coverage hole with a non-line-of-sight area caused by various obstacles.

An active RIS using liquid crystal (LC) can be used at a higher frequency band than existing semiconductor devices, and with lower costs and lower complexity. Due to the drive voltage level and response time of a LC for a radio frequency (RF) field, a cell-gap between each substrate to fill the liquid crystal should be reduced to less than tens of microns. However, if the cell-gap is made to be thicker than tens of microns, it is difficult to widen the dynamic range of the reflection phase change according to bias voltages. For this reason, it is very difficult to design active RIS with a LC using a small cell-gap. However, various advantages occur when the thickness is reduced, such as an increase in reaction speed, the possible application of a display process, and a decrease in driving voltage. So, a small cell-gap LC RIS is desirable with an appropriate operating method to form the desired scattered waves with the designed unit-cell structures.

Embodiments of the present disclosure include a unit-cell design for active RIS with a LC having an extremely thin cell-gap (e.g., less than 35 μm) and its operation method using an optimization algorithm. To reduce the thickness of the cell-gap of the spacer, the unit cell includes a circular and ring-shaped resonator formed on the upper and lower surfaces of dielectric substrates.

The unit-cells described herein are designed to change the resonance frequency sensitively according to the variation of the relative permittivity of LC by application bias voltages. A true 360° reflection phase variation is very difficult to achieve because a LC with a thin cell-gap has a dynamic range of relative permittivity. As a result, embodiments utilize 1-bit quantized unit-cells using a 180° reflection phase variation. To build this RIS design, the 1-bit quantized unit-cell condition should satisfy a high reflection coefficient. Since the proposed design should work as a reflector, the magnitude of the reflection coefficients and the phase are each considered. For this reason, the proposed design has almost the same magnitude of reflection coefficient while maintaining a high reflectance with a 180° reflection phase difference. To meet this condition, the unit-cells described herein are designed to resonate in the target frequency band at the mid-point value between the smallest permittivity (horizontally aligned LC molecules) and the largest permittivity (vertically aligned LC molecules).

Embodiments also include a stochastic-based beamforming optimization algorithm to achieve reflected waves in the desired direction using the designed unit-cell as described above. The proposed algorithm is a method for finding an optimized arrangement of 1-bit quantized unit-cells, and through the proposed algorithm, a reflected beam in a desired direction can be obtained with the optimized arrangement. The proposed algorithm can be implemented with various optimization techniques such as machine learning (ML), artificial intelligence (AI), gradient descent, particle swarm, genetic algorithm (GA), randomly, and so forth. In this case, a genetic algorithm (GA) is introduced as an example.

There are advantages of the small cell-gap designs and the proposed optimization algorithms for unit-cell arrays. First, in terms of LC performance, the small cell-gap for an active LC RIS can reduce the response time (switching speed), input bias voltage levels (power consumption), and side effects. Next, from a production point of view, the LC filling process of a modern LCD mass-production line can perform fabrication while limiting the size of LC cells to several microns. For this reason, the limited small cell-gap unit-cell can be mass-produced through current processes. Furthermore, it is possible to quickly find conditions that scatters reflected waves at a target angle using the proposed optimization algorithm with 1-bit quantized unit-cells. Finally, the proposed algorithm can reduce sidelobe levels and eliminate the lobes being created by unwanted interferences.

It is noted that LC may be an important factor for telecommunication applications. As shown in Table 1 below, there is a difference in response time depending on the thickness of the unit cell. The time to change from the horizontal to the vertical state with the 20 um-thick cell-gap is about 30 ms, and the time for the 100 um-thick cell-gap is about 400 ms. The time it takes to return to the original state also differs greatly. Thus, the thinner the cell-gap, the faster the reaction rate.

TABLE 1

| | | | | |
|---|---|---|---|---|
| Unit-cell Gap | 20 | μm | 100 | μm |
| τ_{On} | 30 | ms | 400 | ms |
| τ_{Off} | 350 | ms | 18,000 | ms |

Various embodiments of unit cells, wireless communications reflectors and methods of fabricating wireless communications reflectors are described in detail below.

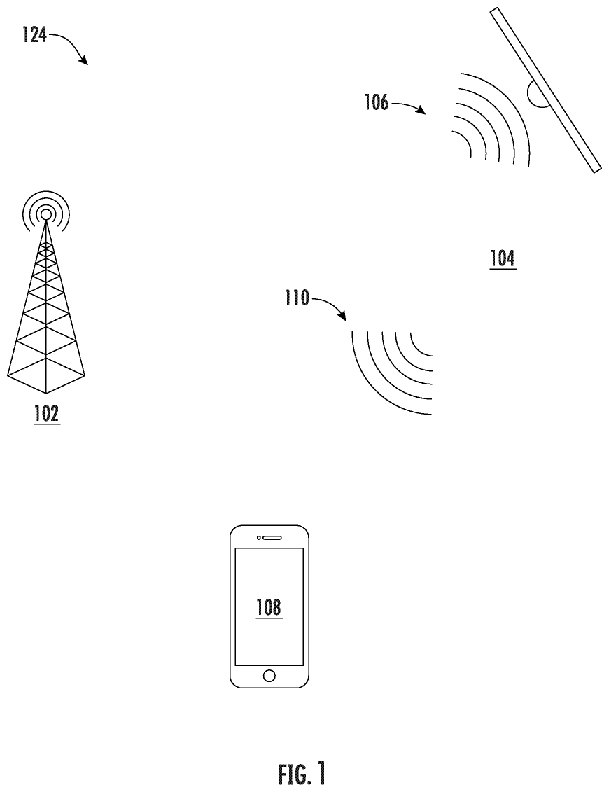

Referring now to FIG. 1, an example wireless communications network 124 including a transmission antenna 102 that is operable to emit an incident wave 106 at a desired frequency such as, without limitation, 30-300 GHz, for receipt by a plurality of user devices 108, such as mobile phones, Internet-of-things devices, media steaming devices, and/or the like. Due to the small wavelength of the incident waves 106 emitted by the transmission antenna 102, the coverage and range of the incident waves 106 are limited. Dead-zones may be present due to obstacles or distance from the transmission antenna 102. Thus, there should be good line-of-sight (LoS) to increase a coverage area with 5G and 6G small cells or repeaters.

The example wireless communications network 124 further includes one or more reflectors 104 that reflect an incident wave 106 as a reflected wave 110 at a desired angle such that the reflected wave 110 reaches a user device 108 at a user device location. As described in detail below, the reflectors 104 described herein are LC RIS comprising an array of unit cells controlled in a pattern by application of bias voltages to reflect the reflected wave 110 at a desired angle.

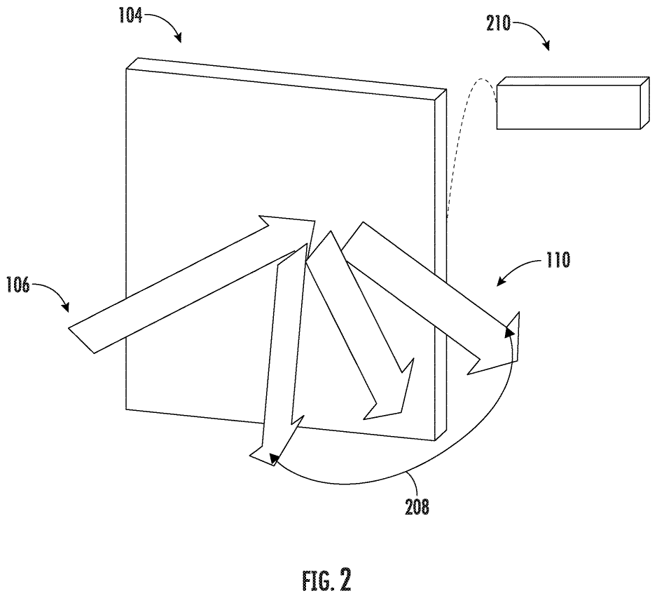

FIG. 2 illustrates an example reflector 104 according to one or more embodiments described herein. A RIS can manipulate the reflected scatters (i.e., beam) to the intended direction. A passive RIS is a deterministic design with an incidence angle and a reflection angle. However, an active RIS can change the angle of the reflected beam using a bias voltage with a driver 210 as a controller. For this reason, an active RIS uses a function to change the reflection phase and a system that can control it to create the desired reflection angle among many reflection angles, as shown by arrow 208. Embodiments use liquid crystals in an active RIS to construct wireless communications reflectors 104 with a low cost and with low complexity. As described in more detail below, the wireless communications reflectors reflector 104 described herein comprise an array of 1-bit quantized unit cells that are controllable between a one-state and a zero-state having a reflection phase difference of approximately 180 degrees between the two states (e.g., a reflection phase difference within a range of 160 degrees to 200 degrees, including endpoints).

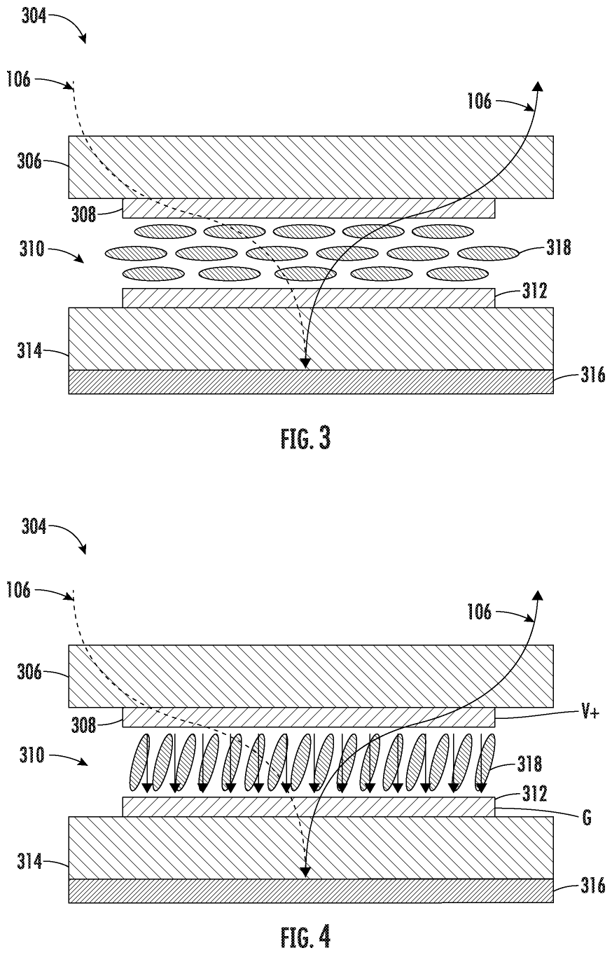

FIG. 3 illustrates an example LC RIS unit cell 304. It should be understood that a reflector 104 includes an array of unit cells 304, with each being positioned in a zero-state or a one-state. The unit cells comprise an electrically conductive ground layer 316, a bottom dielectric layer 314 disposed on ground layer 316, a bottom conductive layer 312 disposed on an upper surface of the bottom dielectric layer 314, a top dielectric layer 306, and a top conductive layer 308 disposed on a bottom surface of the top dielectric layer 306. The word “top” as used herein refers to the surface of a layer that first receives an incident wave 106. The word “bottom” as used herein refers to the surface of a layer through which an incident wave 106 leaves the layer. A liquid crystal layer 310 is disposed and sealed between the top dielectric layer 306 and the bottom dielectric layer 314. The top dielectric layer 306 and the bottom dielectric layer 314 are fabricated from a material having low dielectric loss. As a non-limiting example, the top dielectric layer 306 and the bottom dielectric layer 314 may be fabricated from glass, such as Eagle XG, Gorilla, Astra, NXT, and the like sold by Corning Incorporated of Corning New York. Other materials include ceramics and glass-ceramics.

The zero-state is the LC horizontal state wherein the LC liquid crystal structures 318 are aligned horizontally (i.e., substantially parallel to the top dielectric layer 306 and the bottom dielectric layer 314 such that the unit cell has a 0° reflection coefficient).

FIG. 4 illustrates the unit cell 304 in a one-state with the application of voltage V+ between the top conductive layer 308 and the bottom conductive layer 312. The one-state indicates the vertical state of the LC with a 180° reflection coefficient. The vertical state is also shown by the change of the reflection phase by 180° that can be made even slightly tilted at 90 as shown in FIG. 4. The phase of reflection coefficient with two states should have an approximately 180 reflection phase difference for 1-bit quantization. Therefore, the reflection phase difference between when zero voltage is applied and when a specific voltage is applied should be approximately 180° (e.g., a reflection phase difference within a range of 160 degrees to 200 degrees, including endpoints). A value of a specific voltage V+ is determined by the physical properties and attributes of the LC and of the physical dimension of electrodes.

FIG. 5 is a top-down view of the unit cell 304 shown in FIG. 4, as shown looking down through the top dielectric layer 306. As described in more detail below, each unit cell 304 comprises a ring resonator 604 that changes the resonance frequency sensitivity according to the variation of the relative permittivity of the LC by application of the bias voltage.

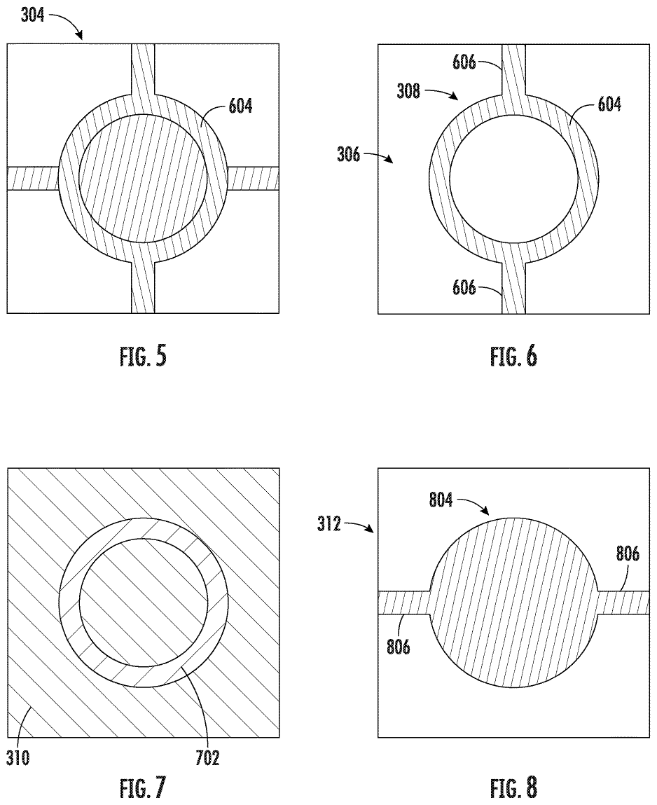

FIG. 6 is a top-down view of the top conductive layer 308 disposed on the top dielectric layer 306. The top conductive layer 308 is fabricated from an electrically conductive material, such as copper, for example. The top conductive layer 308 defines the ring-shape of the ring resonator 604, as well as two top voltage bias line 606 that extend from the ring resonator 604 to an edge of the unit cell 304. In the illustrated embodiment the two top voltage bias lines 606 are orthogonal to two opposite edges of the unit cell 304. However, embodiments are not limited to this arrangement. Further, more or fewer than two top voltage bias lines 606 may be provided.

FIG. 7 is a top-down view of the liquid crystal layer 310. The vertical alignment of the ring resonator 604 and portions of the bottom conductive layer 312 define a liquid crystal switching area 702. Only the liquid crystal structures 318 within the liquid crystal switching area 702 change states when a bias voltage between the top conductive layer 308 and the bottom conductive layer 312 is applied or removed. However, it should be understood that there is some LC change in the fringe field nearby the ring-shaped structure.

FIG. 8 illustrates a top-down view of the bottom conductive layer 312 disposed on the bottom dielectric layer 314 of the unit cell 304. The bottom conductive layer 312 defines a conductive structure 804 having a shape that corresponds to the ring resonator 604 such that the overlap between the ring resonator 604 and the conductive structure defines the liquid crystal switching area 702. In the illustrated embodiment, the conductive structure 804 has a disc shape that has a diameter matching the diameter of the ring resonator 604. It should be understood that the ring resonator 604 and the conductive structure 804 are not limited to a circular shape, and that other shapes may be utilized.

The bottom conductive layer 312 also includes two lower voltage bias lines 806 that extend from the conductive structure 804 toward edges of the unit cell 304. The lower voltage bias lines 806 are orthogonal to the top voltage bias lines 606 so that the two do not vertically overlap to avoid liquid crystal state changes outside of the liquid crystal switching area 702. A reference potential (e.g., ground) may be applied to the lower voltage bias lines 806. A LC state change is achieved by adding or removing a bias voltage between the top voltage bias lines 606 and the lower voltage bias lines 806.

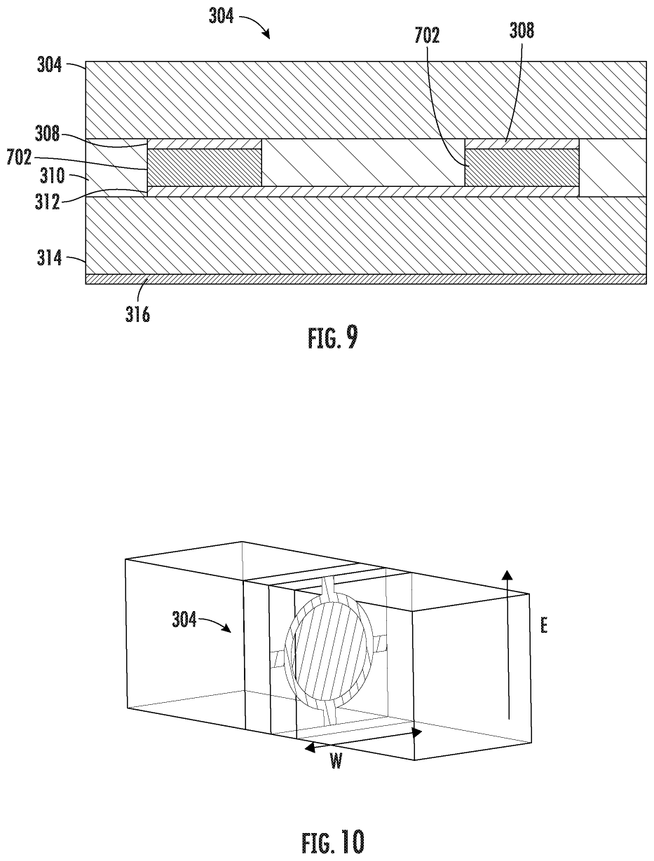

Referring now to FIG. 9, a cross-sectional view of a unit cell 304 is illustrated. In this embodiment, a common ground layer 316 is provided on a bottom surface of the bottom dielectric layer 314. The common ground layer can prevent the leakage of incident waves and stabilize the RF performance and the bias voltage for the LC control. When the liquid crystal layer 310 is injected between the top dielectric layer 306 and the bottom dielectric layer 314, an electric field (E-field) is applied only to the overlapped area between the top dielectric layer 306 and the bottom dielectric layer 314. Therefore, the liquid crystal switching area 702 where the liquid crystal actually changes is only in the ring-shaped region defined by the top conductive layer 308. For this reason, when electromagnetic (EM) simulation is performed, the change in the LC state due to the bias voltage can be equalized by the change in permittivity in the ring-shaped region.

The change of the dielectric constant in the ring region (i.e., the LC filled area receiving the E-field) can change the resonance frequency by changing the bias voltages. This leads to changing the effective electrical size of the ring-shaped region. Thus, a change in the resonant frequency creates a reflection phase change. The illustrated example shows a ring-shaped top conductive layer 308 and a circular bottom conductive layer 312; however other shapes can be used for 1-bit quantized RIS if a 180° reflection phase difference can be achieved.

The design provides for a LC RIS with a small gap G between top dielectric layer 306 and the bottom dielectric layer 314. The top dielectric layer 306 and the bottom dielectric layer 314 may be made of thin glass. For example, the top dielectric layer 306 may have a first thickness T1 and the bottom dielectric layer 314 may have a second thickness T2 that are within a range of 0.5 mm to 2 mm, including endpoints. As a non-limiting example, the first thickness T1 and the second thickness T2 is 0.7 mm and the gap G is 20 μm. For liquid crystal RF applications, the dielectric constant of LC varies between about 1 and 4.

To validate the unit cell 304 structure, it was analyzed using an electro-magnetic (EM) simulation. FIG. 10 shows an example unit cell 304 in an EM simulation. The first thickness T1 and the second thickness T2 was 0.7 mm and the gap G was 20 μm. The width W of the simulated unit cell 304 was 2.7 mm. FIG. 10 further shows the direction of the E-field by arrow E.

The EM simulation proceeds with a periodic boundary condition assuming an infinite periodic structure of unit cells 304. The incident wave was set to a plane wave. By optimizing the physical dimension of the unit-cell design for LC RIS, the results satisfy the reflection magnitude and phase of desired values.

When the thickness of substrates is thick enough, the effective length of the substrate changes due to the change in the relative permittivity by voltage bias, so that a dynamic range of reflection phase differences can be created by increasing the path. However, to make a wider dynamic range of reflection phase change in a very thin thickness, a resonance phenomenon should be used. When the resonance occurs in this way, the magnitude of the reflection coefficient can be very small, which means that the designed structure can act as an EM absorber. To avoid this, the most optimized pattern design with low loss by absorption should be used. In order to satisfy the largest reflection coefficient and phase, the magnitude and phase should be obtained as shown in FIGS. 11-14. As a result, a resonance can be made at a point slightly out of the target frequency band to induce a reflection phase change and the size of the reflection coefficient to be the largest. After minimizing the reflection losses, another factor is that the magnitudes of the reflection coefficients in the two states for 1-bit quantization should be on the same level. This can check the beam tilting characteristics by phase change with the antenna array factor. In this case, the array factor can be solved more easily. This is because it should be designed with the same value in consideration of the actual situation.

FIG. 11 plots the amplitude of a reflected wave for a frequency f₀ versus voltage for both the zero-state and the one-state. The liquid crystal layer begins to change from the zero-state to the one-state at the threshold voltage Vth. The one-state voltage V₁ is chosen such that there is a minimal difference between the amplitude of the reflected wave at the zero-state and the amplitude of the reflected wave at the one-state. It is desired to provide minimal reflection losses at both the zero-state and the one-state.

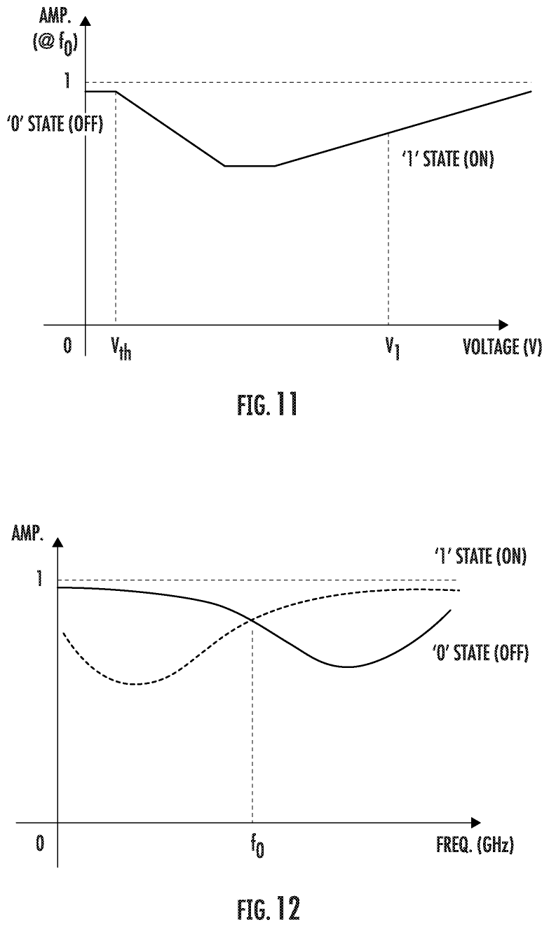

FIG. 12 plots the amplitude of a reflected wave versus frequency for both the zero-state and the one-state. Resonance can be achieved symmetrically at around frequency f₀ that provides a substantially equal amplitude of the reflected wave in both the zero-state and the one-state, thereby achieving a substantially similar reflection coefficient for both the zero-state and the one-state.

FIG. 13 plots the reflection phase in degrees versus voltage for both the zero-state and the one-state. It is desired to achieve a 180 degree reflection phase difference between the zero-state and the one-state. As shown by FIG. 13, the voltage V₁ is chosen for the one-state because it provides approximately a 180 degree reflection phase difference.

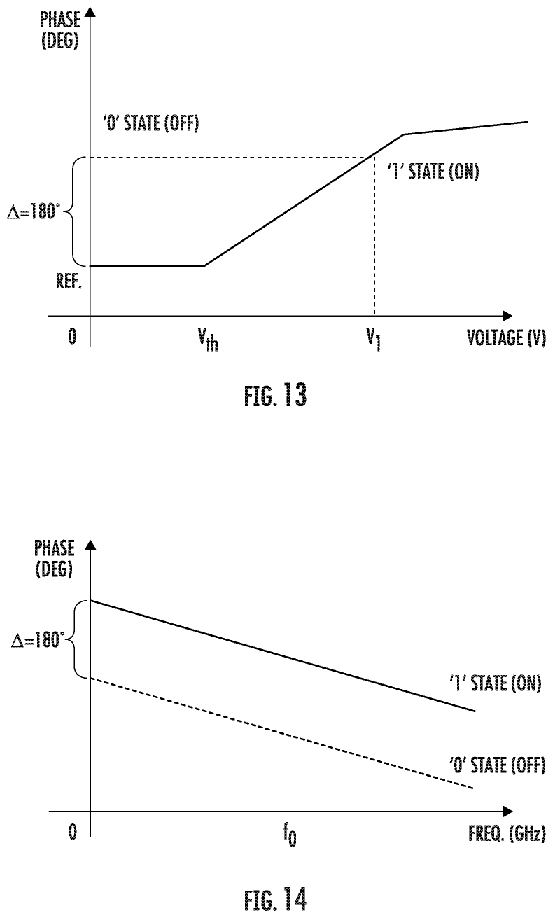

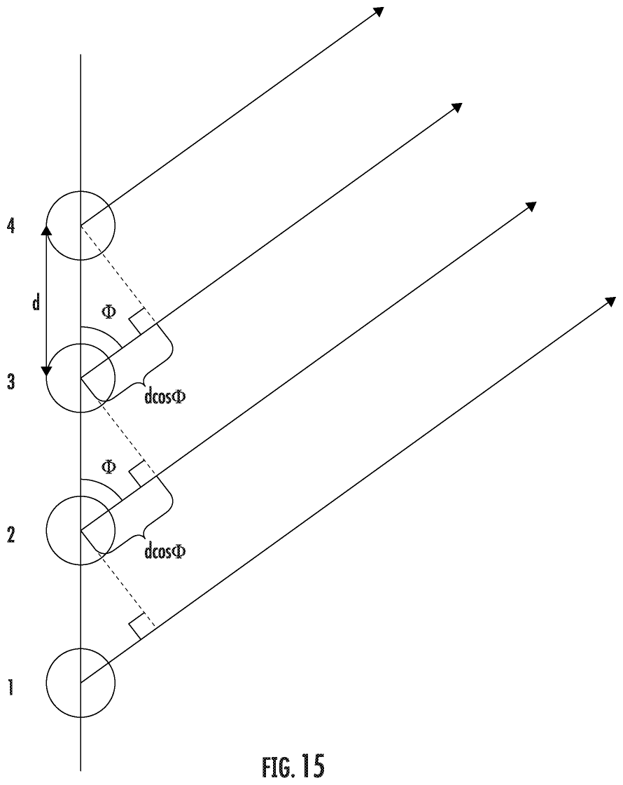

FIG. 14 plots the reflection phase in degree versus frequency for both the zero-state and the one-state. The simulated unit cell provides for a 180 degree reflection phase difference between the zero-state and the one-state over a range of frequencies, including frequency f₀ of FIG. 12 that provides a substantially equal amplitude of the reflected wave in both the zero-state and the one-state.

FIG. 15 illustrates the array of unit cells 304 for LC RIS reflector 104. The desired progressive phase can be obtained with uniform array configuration by Equation (1)-(3). Where θ is target reflection angle and ‘d’ is distance between each unit-cell 304 and β is the excitation angle and N is number of elements and ‘k’ is propagation constant. Based on the calculated the progressive phase, a 1-bit quantization can be performed. However, the unit cell arrangement calculated in the above manner causes performance degradation due to quantization error of the quantized phase, so additional unit cell optimization arrangement work is performed to ensure optimal performance.

$$A F = {\sum }_{n = 1}^{N} {e}^{j ( n - 1 ) Ψ} \qquad ( 1 )$$

$$where Ψ = kd cos θ + β$$

$$( AF ) {e}^{j Ψ} = {e}^{j Ψ} + {e}^{j Ψ} + {e}^{j Ψ} + … + {e}^{j ( N - 1 ) Ψ} + {e}^{j N Ψ} \qquad ( 2 )$$

$$AF ( {e}^{j Ψ} - 1 ) = ( - 1 + {e}^{j Ψ} )$$

$$AF = [ \frac{{e}^{j Ψ N} - 1}{{e}^{j Ψ} - 1} ] = {e}^{j [ \frac{N - 1}{2} ] Ψ} [ \frac{{e}^{j ( \frac{N}{2} ) Ψ} - {e}^{- j ( \frac{N}{2} ) Ψ}}{{e}^{j ( \frac{1}{2} ) Ψ} - {e}^{- j ( \frac{1}{2} ) Ψ}} ] = {e}^{j [ ( N - 1 ) / 2 ] Ψ} [ \frac{sin ( \frac{N}{2} Ψ )}{sin ( \frac{1}{2} Ψ )} ] \qquad ( 3 )$$

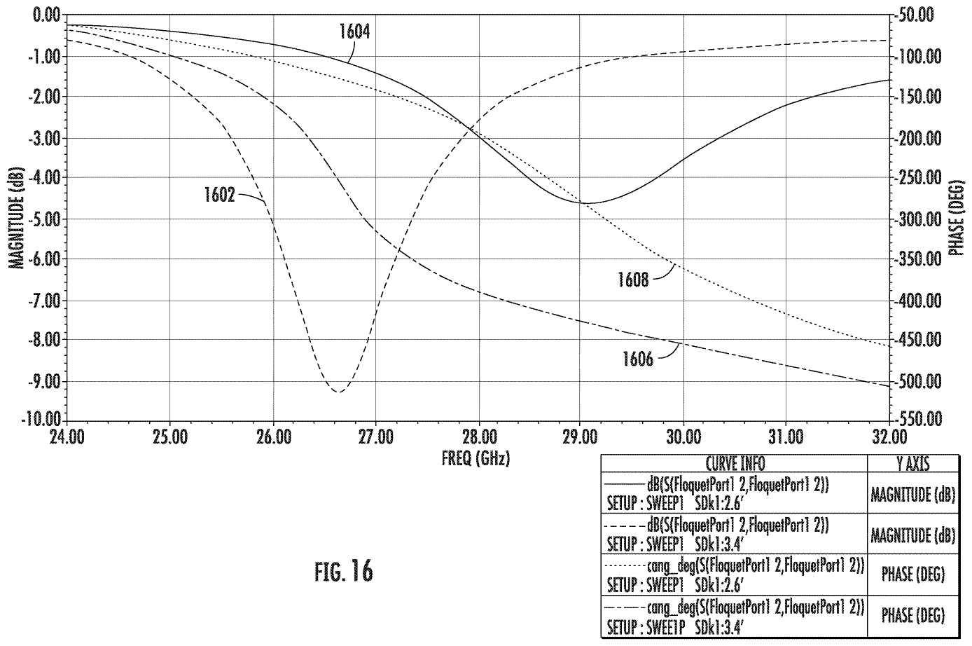

FIG. 16 shows the EM simulated results of an LC RIS unit cell optimized for the conditions illustrated by FIGS. 11-14. FIG. 16 plots both the reflection magnitude and phase for both the zero-state and the one-state over a range of frequencies. As stated above, it is desired to have a substantially similar magnitude for a reflected wave at both the zero-state and the one-state, and approximately a 180 degree reflection phase difference between the zero-state and the one-state. Curve 1602 and curve 1608 represent the magnitude and phase, respectively, of simulated reflected waves when the unit cell 304 is in the zero-state. Curve 1604 and curve 1606 represent the magnitude and phase, respectively, of simulated reflected waves when the unit cell 304 is in the one-state.

The simulation of FIG. 16 shows that a magnitude difference of 0.4 (−2.6 dB for the zero-state and −3.0 for the one-state) at 28 GHz, meaning the reflective coefficients of the zero-state and the one-state are substantially equal. Further, the reflected phase difference between the one-state and the one-state is 194 degrees at 28 GHz, which is about the desired 180 degrees. Because the size of the reflection coefficient is similar in both states, and the reflected phase difference is close to 180 degrees, the unit cell 304 may be used as a 1-bit quantized unit cell.

After designing a unit-cell having a desired performance through the process described above, the resulting 1-bit quantization unit cell can be optimized for inclusion in an array of unit cells defining a wireless communications reflector for beam tilting in a desired direction. FIG. 17 illustrates an array 902 of unit cells 304 that may define a wireless communications reflector, for example. In this example, each individual unit cell 304 is set to the zero-state. As shown in FIG. 17, when all of the unit cells 304 of the array 902 are in the same state (e.g., zero-state), the reflected wave scatters are reflected by the specular reflection of the angle of incidence θᵢ, and thus have an angle of reflection θᵣ₁ that is equal to the angle of incidence θᵢ.

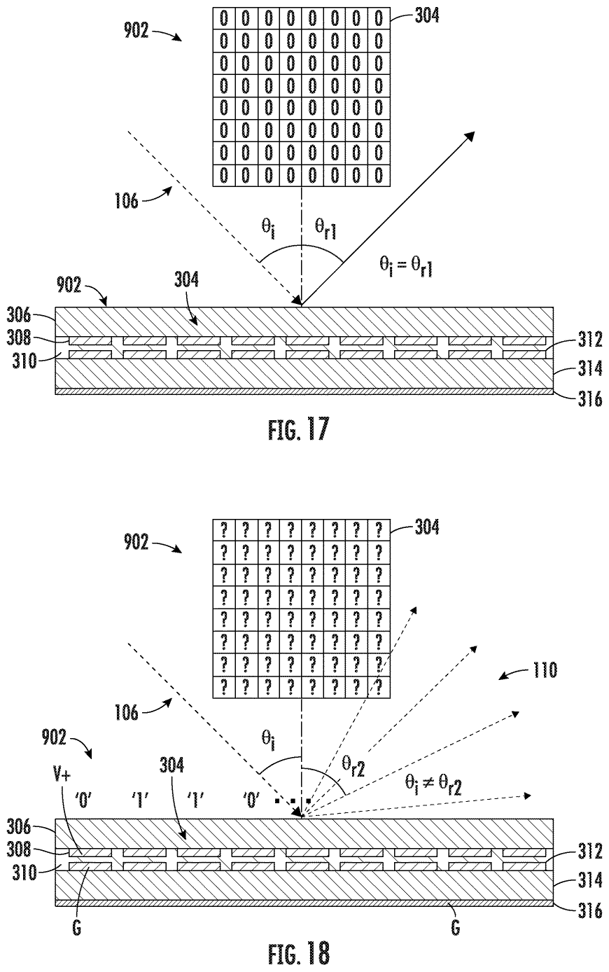

FIG. 18 illustrates the same array 902 of unit cells 304 but with randomized state values for the individual unit cells 304. The state values for the unit cells 304 define a state pattern that produces a certain reflection angle θᵣ₂ that is not equal to the angle of incidence θᵢ. Thus, different state patterns produce different reflection angles θᵣ₂. The reflection angle θᵣ₂ can be controlled in the desired direction when the state patter is established by optimization.

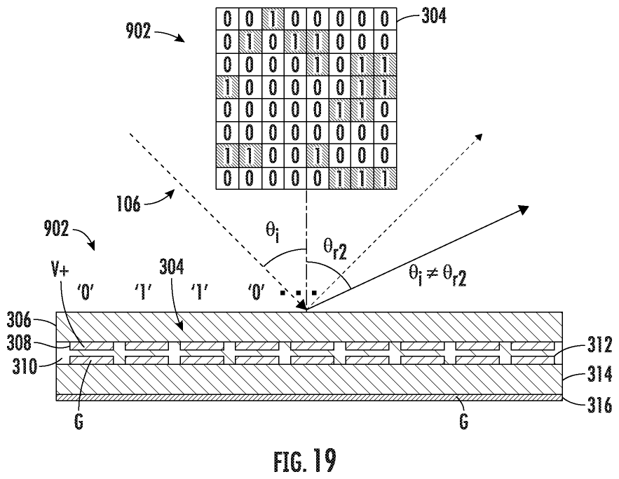

FIG. 19, shows that a target reflection angle θᵣ₂ in a desired direction can be created through the optimized arrangement of unit cells 304 per a particular state pattern. In other words, each individual unit cell 304 can be controlled to be in a zero-state or a one-state so that the state pattern yields a target reflection angle θᵣ₂. However, because there are so many variables into designing the array 902 of unit cell 304 to achieve a target state pattern, it may be difficult and time consuming to determine the optimized state pattern resulting in a target reflection angle. In embodiments, a method provides an optimization process to determine an optimal state pattern.

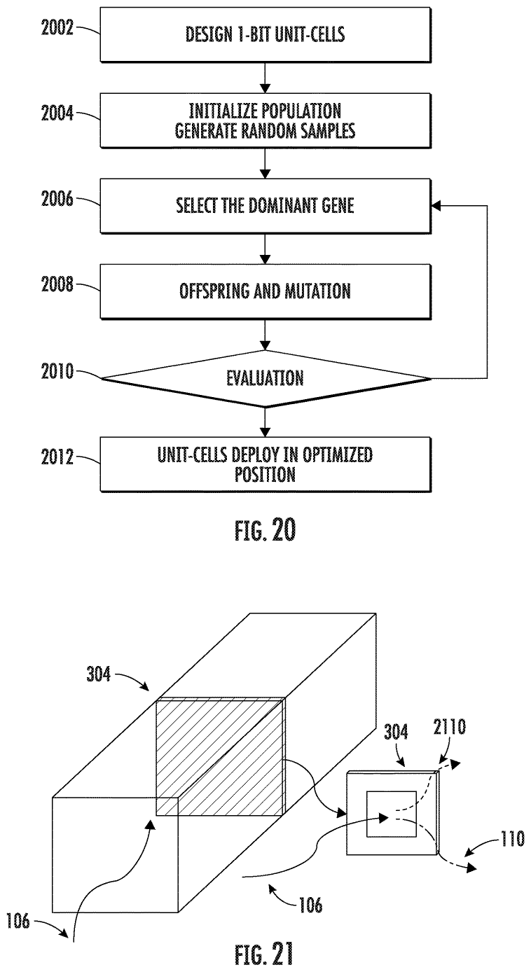

Referring now to FIG. 20, an example method for designing and fabricating a wireless communications reflector 104 comprising an array 902 of unit cells 304 is illustrated. The resulting wireless communications reflector 104 provides a target reflection angle of a reflected wave 110 for an incident wave 106 having a certain angle of incidence and frequency.

At block 1002, an individual unit cell 304 is designed. As stated above, the properties of the unit cell 304 are designed such that the coefficient of reflection of the unit cell are substantially equal at a target frequency for both the zero-state and the one-state, and the unit cell as a reflected phase difference of approximately 180 degrees between the zero-state and the one-state such that the unit cell may be utilized as a 1-bit quantization unit cell. The properties of the top dielectric layer 306 and the bottom dielectric layer 314, the shapes of the top conductive layer 308 and the bottom conductive layer 312, and properties of the liquid crystal layer 310 may be adjusted to meet the aforementioned design considerations.

Referring to FIG. 21, the 1-bit quantized unit cell 304 may be designed using a full-wave simulator with a plane wave test in the periodic boundary condition. In the simulation, an incident wave 106 is incident on a unit cell 304, where a portion of the incident wave 106 is reflected as a reflected wave 110 and a portion of the incidence wave is transmitted or absorbed as a transmitted wave 2110 (or absorbed wave). As stated above, the reflected wave 110 should be such that the unit cell 304 has substantially the same magnitude of reflection in both the zero-state and the one-state. Additionally, the reflected phase difference between the zero-state and the one-state should be approximately 180 degrees.

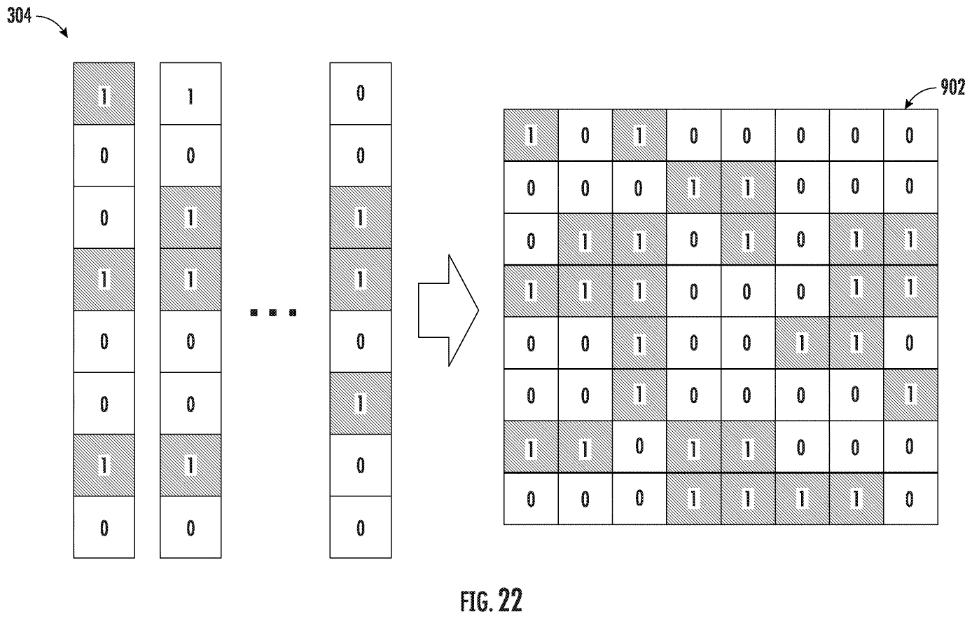

Referring once again to FIG. 20, at block 2004 randomized samples are generated to randomly assign a zero-state or a one-state to each unit cell 304 of the array 902. A binary random variable generator may be used to establish the states of the array 902. As shown in FIG. 22, random state values are assigned to each unit cell (left side of FIG. 22) to yield an array 902 of unit cells 304 having a random state pattern (right side of FIG. 22). The reflected waves are determined using the array factor.

At block 2006 of FIG. 20 the dominant gene is selected by a comparison of previous iterations (i.e., comparison groups) with respect to a cost function, which in this case is a difference in the angle of reflection of the simulated reflected wave and the desired angle of reflection (e.g., thirty degrees). In the first iteration or early iterations, the dominate gene may be unknown because there is not enough data to determine which changes have the biggest impact on the cost function. Therefore, unit cells may be randomly selected as the dominate gene early in the iterative process.

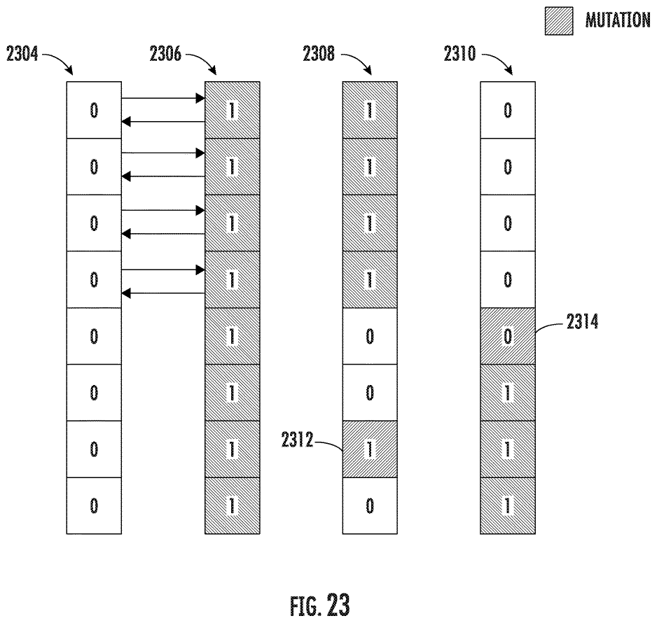

Referring to FIG. 23, a gene in this case may be an individual column of the array 902 (or row). When changes are made in the form of mutations, it is determined which changes have the best effect (i.e., the dominant genes) on minimizing the cost function. In FIG. 23, column 2304 is a first parent and column 2306 is a second parent. Referring again to FIG. 20, at block 2008 offspring between parents are generated. In the example of FIG. 23, column 2308 is a first child of the first and second parents, and column 2310 is a second child of the first and second parents. The first child shown by column 2308 receives its top four unit cells from the second parent (column 2306) and its bottom four unit cells from the first parent (column 2304). The second child shown by column 2310 receives its top four unit cells from the first parent (column 2304) and the bottom four unit cells from the second parent (column 2306). Thus, each child receives unit cells from each parent.

Further at block 2008 of FIG. 20, mutations are generated for the offspring (e.g., the first child and the second child of FIG. 23). The mutations are the changing of a one-state unit cell to a zero-state unit cell and a zero-state unit cell to a one-state unit cell. In the example of FIG. 23 there are a first mutated cell 2312 where the mutation is from a zero-state to a one-state and a second mutated cell 2314 where the mutation is from a one-state to a zero-state. It should be understood that any number of mutations may be generated for each gene (i.e., each column or row of the array 902.

At block 2010 the array 902 having the new mutations is evaluated. For example, an electro-magnetic simulation is performed to determine a reflection angle, which is compared with the desired reflection angle in accordance with the cost function. When the cost function is not satisfied, the process returns to block 2006 where one or more dominant genes are selected, such as by comparing the previous results derived at block 2010. Additional offspring and mutations are generated in a plurality of iterations until the cost function is satisfied at block 2010 (i.e., either the simulated reflection angle equals the desired reflection angle or there is no improvement over a previous number of iterations).

After the cost function is satisfied at block 2010, the process moves to block 2012 where an array 902 having the optimized state pattern is created. The optimized array 902 may be fabricated and deployed in a wireless communications reflector.

It should be understood that iterative optimization algorithms other than a genetic algorithm may be used to determine the optimal state pattern, such as, without limitation, a topology optimization algorithm.

Not only can the method of FIG. 20 be used for 1-bit quantization for a 180 degree reflected phase difference, it can also be used for a 1-bit quantization for the magnitude of reflection where in the zero-state the magnitude of reflection coefficient size is 1 (i.e., 100% reflection) and in the one-state the magnitude of reflection coefficient is set to 0 (i.e., the amplitude of reflection is around 0).

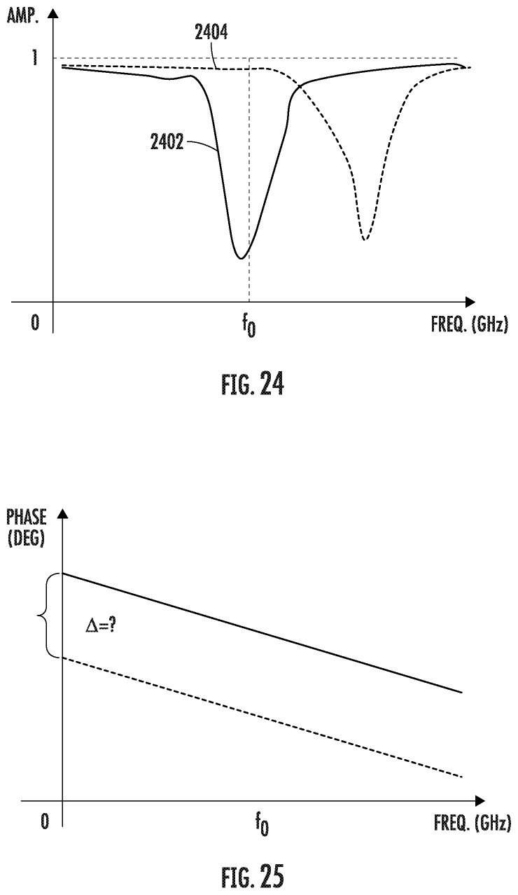

FIG. 24 illustrates the magnitude of the reflection coefficient for each unit cell state. Curve 2402 shows that the magnitude of the reflection coefficient is near zero for the one-state at a frequency f₀. Curve 2404 shows that the magnitude of the reflection coefficient is near 1 for the zero-state at the frequency f₀.

FIG. 25 illustrates the phase of reflection coefficient for each unit cell state. However, because the phase has no practical meaning when the magnitude of reflection coefficient is zero, the reflected phase difference between the one-state and the zero-state is meaningless.

Therefore, rather than quantizing the phase difference by 1-bit quantization, the magnitude of the reflection coefficient may be quantized by 1-bit quantization. The magnitude of the reflection coefficient of the unit cells of an array may be optimized (e.g., by the genetic algorithm illustrated by FIG. 20) to achieve an overall angle of reflection at a desired reflection coefficient.

It should now be understood that embodiments of the present disclosure are directed to wireless communications reflectors having a RIS comprised of an array of unit cells to improve propagation channel conditions between base stations and mobile devices. The unit-cells described herein have a very small cell gap and are designed to change the resonance frequency sensitively according to the variation of the relative permittivity of LC by application bias voltages. The unit cells may be 1-bit quantized using a 180° reflected phase variation or 0 to 1 reflection coefficient to achieve a desired reflection angle and reflection coefficient for the reflector. Embodiments also are directed to methods for determining an optimal state pattern for the unit cells of the reflector to achieve the desired reflection angle and reflection coefficient.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

What is claimed is:

1. A unit cell for a reconfigurable intelligent surface of a wireless communications reflector, the unit cell comprising:
a top dielectric layer;
a top conductive layer disposed on a surface of the top dielectric layer, wherein the top conductive layer comprises a ring resonator and at least one top voltage bias line electrically coupled to the ring resonator;
a bottom dielectric layer;
a bottom conductive layer disposed on a surface of the bottom dielectric layer facing the top dielectric layer, wherein the bottom conductive layer comprises a conductive structure having a shape corresponding to the ring resonator and further comprises at least one bottom voltage bias line; and
liquid crystal materials positioned between the top dielectric layer and the bottom dielectric layer.

2. The unit cell of claim 1, wherein the ring resonator and the conductive structure each have a circular shape.

3. The unit cell of claim 1, wherein a gap between the top dielectric layer and the bottom dielectric layer is within about 100 μm.

4. The unit cell of claim 3, wherein the gap is within a range of 2 to 35 μm, including endpoints.

5. The unit cell of claim 1, wherein the top dielectric layer and the bottom dielectric layer are each fabricated from glass, ceramics, or organic substrates.

6. The unit cell of claim 1, further comprising a ground layer disposed on a bottom surface of the bottom dielectric layer.

7. The unit cell of claim 1, wherein:
the at least one top voltage bias line comprises a first top voltage bias line and a second top voltage bias line; and
the at least one bottom voltage bias line comprises a first bottom voltage bias line and a second bottom voltage bias line.

8. A wireless communications reflector comprising:
a top dielectric layer;
a top conductive layer disposed on a surface of the top dielectric layer,
a bottom dielectric layer;
a bottom conductive layer disposed on a surface of the bottom dielectric layer facing the top dielectric layer, and
a liquid crystal layer disposed between the top dielectric layer and the bottom dielectric layer,
wherein the top conductive layer and the bottom conductive layer define an array of unit cells, each unit cell comprising:
a ring resonator and at least one top voltage bias line electrically coupled to the ring resonator at the top conductive layer, and
a conductive structure having a shape corresponding to the ring resonator and at least one bottom voltage bias line at the bottom conductive layer.

9. The wireless communications reflector of claim 8, wherein the ring resonator and the conductive structure each have a circular shape.

10. The wireless communications reflector of claim 8, wherein a gap between the top dielectric layer and the bottom dielectric layer is within about 100 μm.

11. The wireless communications reflector of claim 10, wherein the gap is within a range of 2 to 35 μm, including endpoints.

12. The wireless communications reflector of claim 8, wherein the top dielectric layer and the bottom dielectric layer are each fabricated from glass, ceramics, or organic substrates.

13. The wireless communications reflector of claim 8, further comprising a ground layer disposed on a bottom surface of the bottom dielectric layer.

14. The wireless communications reflector of claim 8, wherein:
each unit cell is configured to be set to a zero-state or a one-state based on a voltage differential applied to the at least one top voltage bias line and the at least one bottom voltage bias line; and
there is a phase difference within a range of 160 degrees to 200 degrees, including endpoints, between a phase of waves reflected from the unit cell in the zero-state and a phase of waves reflected from the unit cell in the one-state.

15. The wireless communications reflector of claim 14, wherein each unit cell has a magnitude of reflection coefficient in the zero-state that is within fifteen percent of the magnitude of reflection coefficient in the one-state.

16. The wireless communications reflector of claim 14, wherein:
each unit cell is set to the zero-state or the one-state to define a state pattern for the array of unit cells; and
the state pattern results in a reflection angle of a reflected wave for an incident wave having a predetermined frequency.

17. The wireless communications reflector of claim 14, wherein:
a tₒₙ time of each unit cell is within 100 ms; and
a t_{off} time for each unit cell is within 1 sec, including endpoints.

18. A method of fabricating a wireless communications reflector, the method comprising:
establishing an array of unit cells comprising:
a top dielectric layer;
a top conductive layer disposed on a surface of the top dielectric layer,
a bottom dielectric layer;
a bottom conductive layer disposed on a surface of the bottom dielectric layer facing the top dielectric layer, and
liquid crystal materials positioned between the top dielectric layer and the bottom dielectric layer,
wherein the top conductive layer and the bottom conductive layer define the array of unit cells, each unit cell comprising:
a ring resonator and at least one top voltage bias line electrically coupled to the ring resonator at the top conductive layer, and
a conductive structure having a shape corresponding to the ring resonator and at least one bottom voltage bias line at the bottom conductive layer, wherein:
each unit cell is configured to be set to a zero-state or a one-state based on a voltage differential applied to the at least one top voltage bias line and the at least one bottom voltage bias line; and
there is a phase difference within a range of 160 degrees to 200 degrees, including endpoints, between a phase of waves reflected from the unit cell in the zero-state and a phase of waves reflected from the unit cell in the one-state;
randomly assigning each unit cell of the array of unit cells to the zero-state or the one-state to define a state pattern for the array of unit cells;
determining, using an iterative optimization algorithm, an optimal state pattern of the array of unit cells for a predetermined reflection angle for a reflected wave for an incident wave having a predetermined frequency.

19. The method of claim 18, wherein the iterative optimization algorithm iteratively calculates a resulting reflected wave for the state pattern, and generates comparison groups until the optimal state pattern is achieved.

20. The method of claim 18, further comprising performing a full-wave simulation of the wireless communications reflector having the optimal state pattern.
